(19) United States
(12) Patent Application Publication
(10) Pub. No.: US 2008/0093898 A1
(43) Pub. Date: Apr. 24, 2008

(54) Bicycle seat device

(75) Inventor: Hai-Huan Chiang, Nantou Hsien (TW)

Correspondence Address: OSHA LIANG L.L.P., 1221 MCKINNEY STREET, SUITE 2800, HOUSTON, TX, 77010, US

(73) Assignee: CIONLLI INDUSTRIAL CO., LTD., Nantou Hsien (TW)

(21) Appl. No.: 11/879,109

(22) Filed: Jul. 16, 2007

(30) Foreign Application Priority Data
Oct. 23, 2006 (TW) 095218679

(51) Int. Cl. B62J 1/20

(52) U.S. Cl. 297/214

(57) ABSTRACT

A bicycle seat device includes a seat body having a narrow front portion, a wide rear portion, two spaced-apart hole portions provided in the wide rear portion and corresponding in position to the left ischium and the right ischium, respectively, of a rider, top and bottom faces, a base seat extending from the narrow front portion to the wide rear portion and having the bottom face of the seat body, and a cushion covering the base seat from the narrow front portion to the wide rear portion and having the top face of the seat body.

### CROSS-REFERENCE TO RELATED APPLICATION

This application claims priority of Taiwanese Application No. 095218679, filed on Oct. 23, 2006.

### BACKGROUND OF THE INVENTION

1. Field of the Invention

This invention relates to a bicycle seat device, more particularly to a bicycle seat device that can minimize pressure on the left ischium and the right ischium of a rider.

2. Description of the Related Art

In order to provide comfort to a rider of a bicycle, some bicycle seat devices are provided with foam or other damping material on an outer surface thereof, while other bicycle seat devices are provided with a resilient component on a bottom portion thereof for providing a shock-absorbing effect.

Although the aforementioned bicycle seat devices can achieve the purpose of providing comfort to the rider during use of the bicycle, since the left ischium and the right ischium bear the largest pressures, the rider may experience poor blood circulation, and even numbness of the legs, particularly following extended periods of riding.

### SUMMARY OF THE INVENTION

Therefore, the object of the present invention is to provide a bicycle seat device that has a simple structure and that is capable of minimizing pressures on the left ischium and the right ischium during use of a bicycle.

According to this invention, a bicycle seat device comprises a seat body having a narrow front portion, a wide rear portion, and two spaced-apart hole portions provided in said wide rear portion and corresponding in position to the left ischium and the right ischium, respectively, of a rider.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a perspective view of a bicycle seat device according to the first preferred embodiment of the present invention;

FIG. 2 is a sectional view of the first preferred embodiment;

FIG. 3 is a sectional view of a bicycle seat device according to the second preferred embodiment of the present invention;

FIG. 4 is a fragmentary enlarged sectional view, illustrating an alternative form of a hole portion of the bicycle seat device of the second preferred embodiment;

FIG. 5 is an exploded perspective view of a bicycle seat device according to the third preferred embodiment of the present invention;

FIG. 6 is an assembled perspective of the third preferred embodiment;

FIG. 7 is an assembled sectional view of the third preferred embodiment;

FIG. 8 is a fragmentary sectional view of a bicycle seat device according to the fourth preferred embodiment of the present invention; and

FIG. 9 is a fragmentary sectional view of a bicycle seat device according to the fifth preferred embodiment of the present invention.

### DETAILED DESCRIPTION OF THE PREFERRED EMBODIMENTS

Before the present invention is described in greater detail, it should be noted that the same reference numerals have been used to denote like elements throughout the specification.

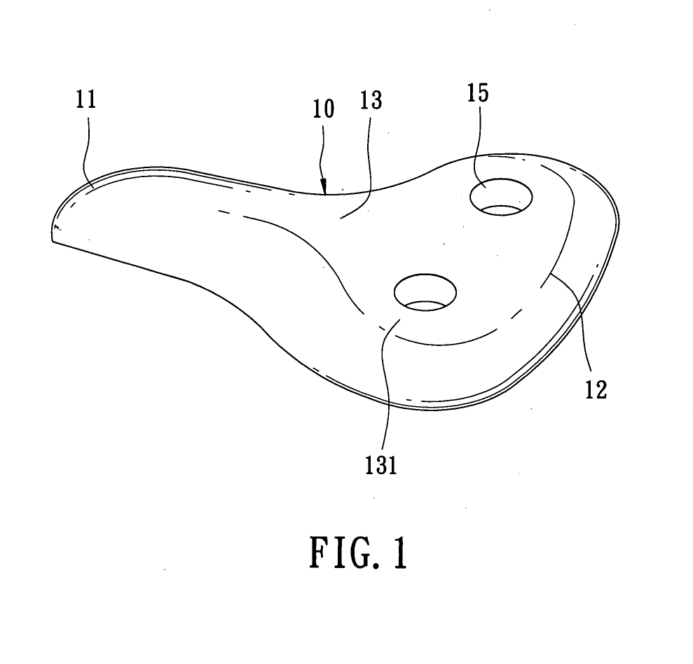

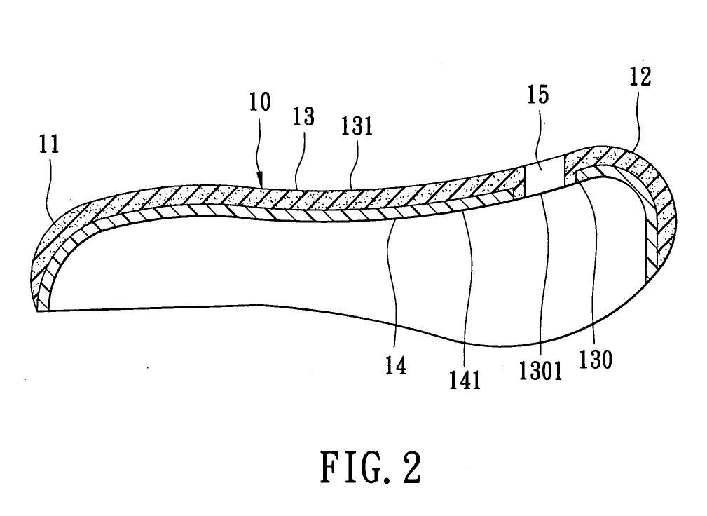

Referring to FIGS. 1 and 2, a bicycle seat device 10 according to the first preferred embodiment of the present invention is shown to comprise a seat body having a narrow front portion 11, a wide rear portion 12, top and bottom faces 131, 141, a base seat 14 extending from the narrow front portion 11 to the wide rear portion 12 and having the bottom face 141 of the seat body, and a cushion 13 covering the base seat 14 from the narrow front portion 11 to the wide rear portion 12 and having the top face 131 of the seat body. Two spaced-apart hole portions 15 are provided in the wide rear portion 12, and correspond in position to the left ischium and the right ischium, respectively, of a user. The cushion 13 has a hollow portion 130 defining the hole portions 15 and extending into the base seat 14. In this embodiment, the hollow portion 130 has an open bottom end 1301 flush with the bottom face 141 of the seat body. The hole portions 15 extend through the top and bottom faces 131, 141 of the seat body.

Hence, through the presence of the hole portions 15, when the user is seated on the bicycle seat device 10, the wide rear portion 12 of the bicycle seat device 10 supports the buttocks of the user with the user's left ischium and right ischium corresponding in position to the hole portions 15, respectively, of the bicycle seat device 10. As a result, pressures borne by the user's left and right ischia are minimized, thereby providing comfort to the user during riding of the bicycle. Hence, the user will not experience any numbness of the legs nor poor blood circulation. Further, with the hole portions 15 extending through the top and bottom faces 131, 141 of the seat body, circulation of air is permitted, thereby providing additional comfort to the user during riding of the bicycle.

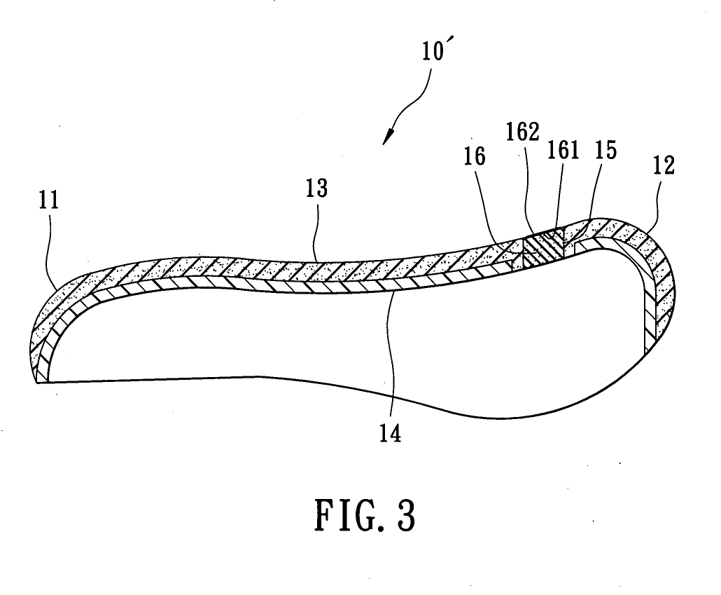

Referring to FIG. 3, a bicycle seat device 10′ according to the second preferred embodiment of the present invention is shown to be similar to the first preferred embodiment. However, in this embodiment, the bicycle seat device 10′ further comprises two shock-absorbing elements 16 (only one is shown) respectively disposed in the hole portions 15. The shock-absorbing elements 16 are made of rubber which is softer than the material of the cushion 13 and the base seat 14. That is, the base seat 14 is made of a rigid plastic material, the cushion 13 is made of a foam material, such as a thermoplastic rubber or elastomer (e.g., TPV, TPU, TPO, etc.), and the shock-absorbing elements 16 may be made of silicone rubber which is softer than the material of the cushion 13. Each of the shock-absorbing elements 16 has a top face 161 flush with the top face 131 of the cushion 13, and a pattern 162 provided on the top face 161. The pattern 162 may be a label, a letter, or a figure. Through the pattern 162, the product name and/or design may be indicated to enhance the value of the product.

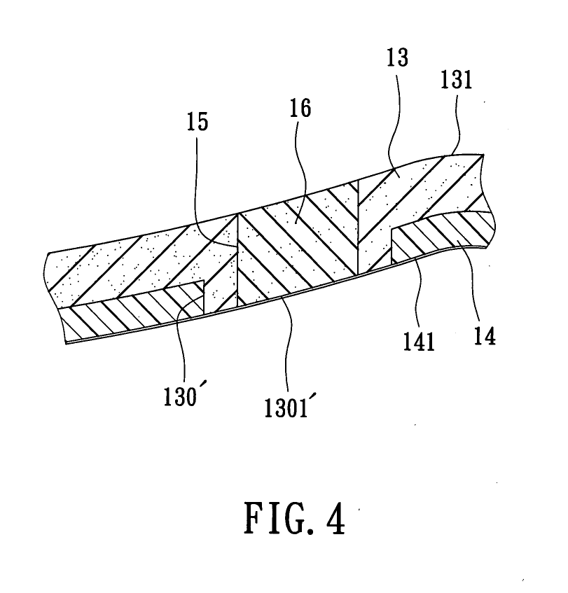

Alternatively, as shown in FIG. 4, the hollow portion 130′ has a closed bottom end 1301′ flush with the bottom face 141 of the seat body. Each of the hole portions 15 (only one is shown) is a blind hole that opens only at the top face 131 of the seat body. Each of the shock-absorbing elements 16 is disposed in the respective hole portion 15.

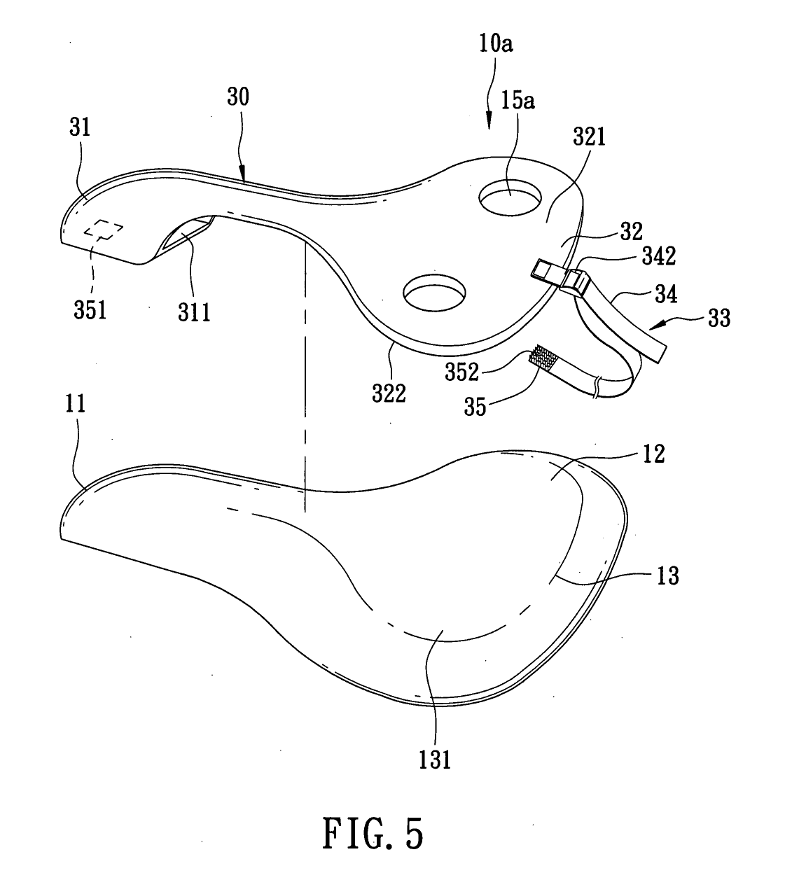

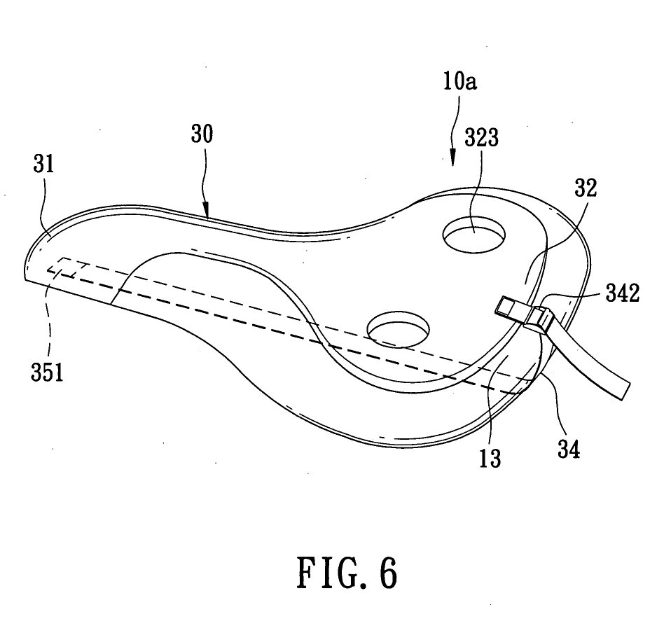

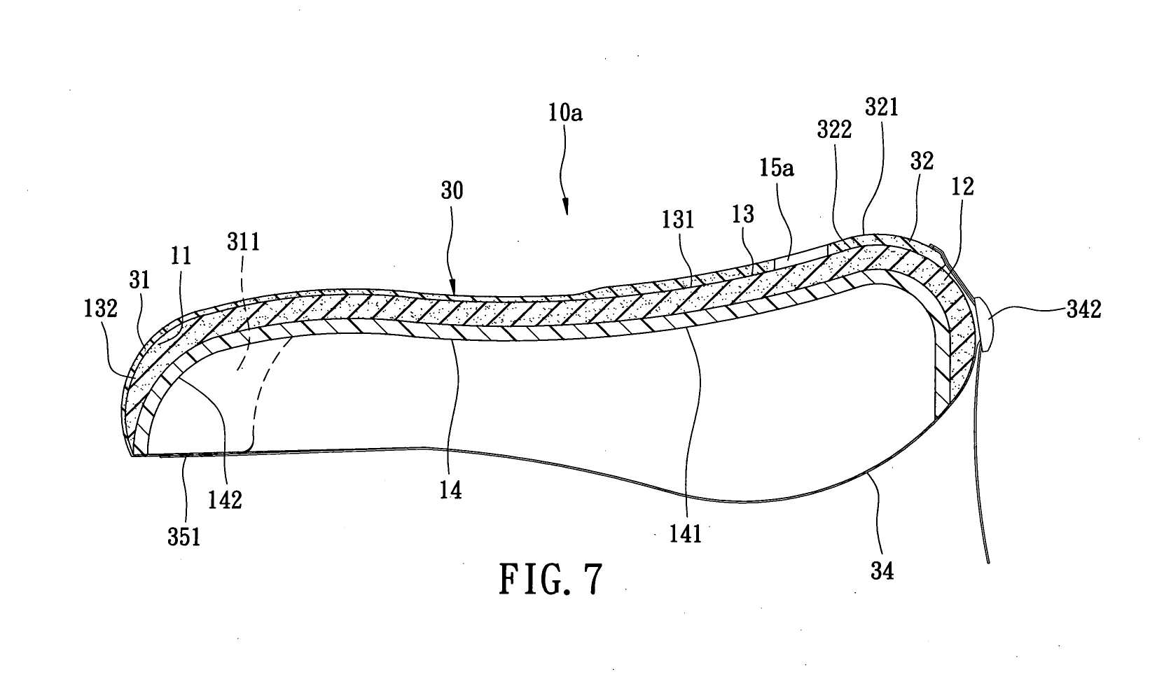

Referring to FIGS. 5, 6, and 7, a bicycle seat device (10a) according to the third preferred embodiment of the present invention is shown to be very similar to the first preferred embodiment. However, in this embodiment, the seat body further comprises a cover member 30. The cover member 30 has a front section 31 extending in the narrow front portion 11, a rear section 32 extending in the wide rear portion 12, and a fastening unit 33. The front section 31 has a front pocket 311. The hole portions 15 penetrate top and bottom faces 321, 322 of the cover member 30 without extending into the cushion 13. The base seat 14 has a nose end 142 in the narrow front portion 11. The cushion 13 has a front end 132 covering the nose end 142 of the base seat 14. The pocket 311 of the front section 31 of the cover member 30 receives therein the nose end 142 of the base seat 14 and the front end 132 of the cushion 13.

The fastening unit 33 includes a strap 34, a hook-and-loop fastener 35, and a retaining ring 342 connected to a rear end of the rear section 32 of the cover member 30. The strap 34 is connected adjustably to the retaining ring 342. The hook-and-loop fastener 35 includes a hook fastener portion 351 fixed to a bottomside of the pocket 311 of the cover member 30, and a loop fastener portion 352 fixed to one end of the strap 34. The strap 34 extends downwardly from the rear end of the rear section 32 of the cover member 30, extends below the bottom face 141 of the base seat 14, and is connected to the bottomside of the pocket 311 by interengagement of the hook and loop fastener portions 351, 352, thereby fastening the cover member 30 to the base seat 14 and the cushion 13. Through the presence of the hole portions (15a) in the cover member 30, pressures borne by the user's left and right ischia are similarly minimized.

Further, the hole portions (15a) may be filled respectively with shock-absorbing elements (not shown). Top faces of the shock-absorbing elements may be respectively provided with patterns.

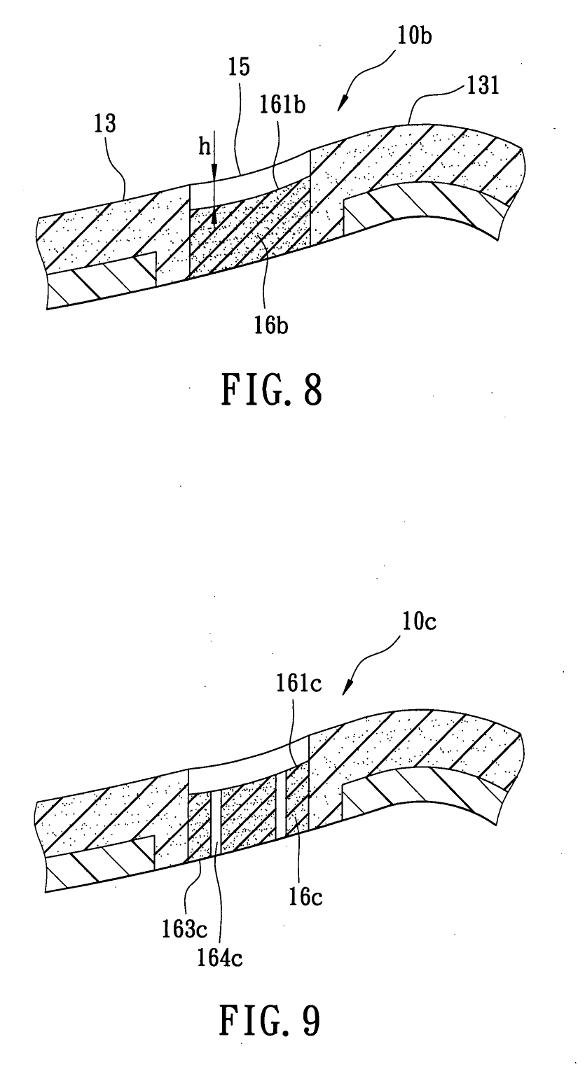

Referring to FIG. 8, a bicycle seat device (10b) according to the fourth preferred embodiment of the present invention is shown to be similar to the second preferred embodiment. However, in this embodiment, the top face (161b) of each shock-absorbing element (16b) is lower than the top face 131 of the cushion 13 by a distance (h). The advantages of the second preferred embodiment can be similarly achieved using the fourth preferred embodiment.

Referring to FIG. 9, a bicycle seat device (10c) according to the fifth preferred embodiment of the present invention is shown to be similar to the fourth preferred embodiment. However, in this embodiment, each shock-absorbing element (16c) further has a bottom face (163c), and a plurality of vent holes (164c) extending through the top and bottom faces (161c, 163c) thereof. The advantages of the fourth preferred embodiment are similarly achieved using the fifth preferred embodiment.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

I claim:

1. A bicycle seat device, comprising:
a seat body having a narrow front portion, a wide rear portion, and two spaced-apart hole portions provided in said wide rear portion and corresponding in position to the left ischium and the right ischium, respectively, of a rider.

2. The bicycle seat device of claim 1, wherein said seat body further includes top and bottom faces, a base seat extending from said narrow front portion to said wide rear portion and having said bottom face of said seat body, and a cushion covering said base seat from said narrow front portion to said wide rear portion and having said top face of said seat body.

3. The bicycle seat device of claim 2, wherein said cushion has a hollow portion defining said hole portions and extending into said base seat.

4. The bicycle seat device of claim 3, wherein said hollow portion has an open bottom end flush with said bottom face of said seat body, said hole portions extending through said top and bottom faces of said seat body.

5. The bicycle seat device of claim 3, wherein said hollow protrusion has a closed bottom end flush with said bottom face of said seat body, each of said hole portions being a blind hole that opens only at said top face of said seat body.

6. The bicycle seat device of claim 2, wherein said seat body further has a cover member covering said cushion from said narrow front portion to said wide rear portion, said hole portions penetrating said cover member without extending into said cushion.

7. The bicycle seat device of claim 6, wherein said cover member has a front section extending in said narrow front portion of said seat body, and a rear section extending in said wide rear portion of said seat body.

8. The bicycle seat device of claim 7, wherein said base seat has a nose end in said narrow front portion, said cushion having a front end covering said nose end, said front section of said cover member having a front pocket that receives therein said nose end of said base seat and said front end of said cushion.

9. The bicycle seat device of claim 7, wherein said cover member further has a fastening unit to fasten said cover member to said base seat and said cushion.

10. The bicycle seat device of claim 9, wherein said fastening unit includes a strap connected to a rear end of said rear section of said cover member, and a hook-and-loop fastener, said strap extending downwardly from said rear end of said rear section of said cover member, extending below said base seat, and being connected to said cover member through said hook-and-loop fastener.

11. The bicycle seat device of claim 2, further comprising two shock-absorbing elements disposed in said hole portions, respectively.

12. The bicycle seat device of claim 11, wherein each of said shock-absorbing elements has a top face provided with a pattern.

13. The bicycle seat device of claim 11, wherein each of said shock-absorbing elements has a top face lower than said top face of said cushion.

14. The bicycle seat device of claim 13, wherein each of said shock-absorbing elements further has a bottom face, and a plurality of vent holes extending through said top and bottom faces of a respective one of said shock-absorbing elements.
